(19) United States
(12) Patent Application Publication
(10) Pub. No.: US 2005/0244214 A1
(43) Pub. Date: Nov. 3, 2005

(54) Vehicle suspension system

(76) Inventors: Kip K. Kilburn, Circleville, UT (US); Roger Allen Winiger, Prather, CA (US)

Correspondence Address: ROBERT T. SPAULDING, 550 ELINOR DR., FULLERTON, CA, 92835, US

(21) Appl. No.: 11/159,861

(22) Filed: Jun. 23, 2005

Related U.S. Application Data
(63) Continuation-in-part of application No. 10/614,250, filed on Jul. 8, 2003.
(60) Provisional application No. 60/393,946, filed on Jul. 8, 2002.

(51) Int. Cl. F16D 1/12

(52) U.S. Cl. 403/122

(57) ABSTRACT

An improved vehicle suspension system in which the conventional upper and lower ball joints, each having a spindle, are replaced by a Hime joint which includes a tapered or straight insert that is dimensioned to accommodate the spindle to which it is attached. The resulting suspension system has enhanced vertical and horizontal travel.

This is a Continuation-In-Part of application Ser. No. 10/614,250 filed Jul. 8, 2003 Applicants claim benefits under 35 U.S.C 119(e) of Provisional Application No. 60/393946 filed Jul. 8 2002.

### BACKGROUND OF THE INVENTION

1) Field of the Invention

This invention relates generally to the suspension mechanisms of multi-wheeled vehicles such as automotive and all terrain vehicle applications. Additionally it can also be used on snowmobile, watercraft, aircraft and motorcycle applications. Specifically, this invention, when inserted into a Hime Joint as compared to a conventional ball joint permits greater travel in the system while dramatically increasing strength and reducing both weight and replacement cost. Because various tapers are available for specific applications, no modification is required to the spindle or knuckle to which it is attached, unlike similar devices.

2) Description of the Prior Art

U.S. Pat. Nos. 5,967,580, 5,845,540, and 4,911,033 describe variants of robotic manipulators that incorporated connected joints. U.S. Pat. No. 4,783,095 shows a suspension system having independent movements of motion. U.S. Pat. No. 4,986,688 shows a ball and socket joint for a vehicle steering system.

Applicants hereby incorporate herein by reference any and all U.S. patents, patent applications, and other documents and printed matter cited or referred to in this application.

### SUMMARY OF THE INVENTION

The connected joints of the prior art comprise a plurality of articulated joints henceforth individually referred to as a ball joint. Dimensionally, the Hime Joint is similar in size to a conventional ball joint or tie rod end found in selected vehicle suspension systems. While it does offer the rotational capability of the ball joint, it lacks the connecting insert to allow it to act as a ball joint or tie rod end. The newly invented tapered, or alternatively, straight insert provides that added capability.

When the conventional upper and lower ball joints or tie rod ends are replaced with the Hime Joint and the newly invented tapered or straight insert is installed, new and unexpected results occur. The Hime Joint, when fitted with the newly invented tapered or straight insert provides proportionally greater vertical and or horizontal travel. This extra travel results in a dramatically improved suspension system; one that is up to eighty percent stronger and weighs less than the conventional ball joint system. Additionally the unsprung weight of the suspension system is reduced and handling is vastly improved. Friction is also greatly reduced compared to the conventional style ball joint.

### BRIEF DESCRIPTION OF THE DRAWINGS

FIG. 1 shows an exploded view of the presently preferred embodiment including a securing bolt 1, an upper tapered insert 3, an annular shaped socket 5, a freely movable ball 7, a lower tapered threaded insert 9, a washer 11, and a securing nut 13.

FIG. 2. shows an exploded view of an alternate embodiment including a securing bolt 15, an upper tapered insert 3, an annular shaped socket 5, a freely movable ball 7, a lower tapered insert 17, a washer 11, and a securing nut 13.

### DESCRIPTION OF THE PRESENTLY PREFERRED EMBODIMENT

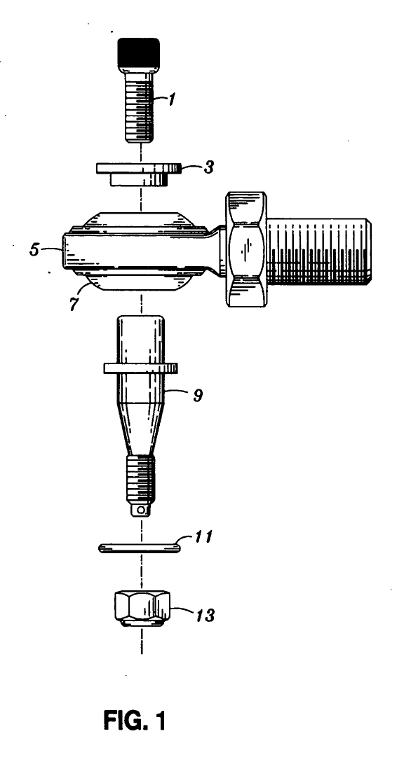

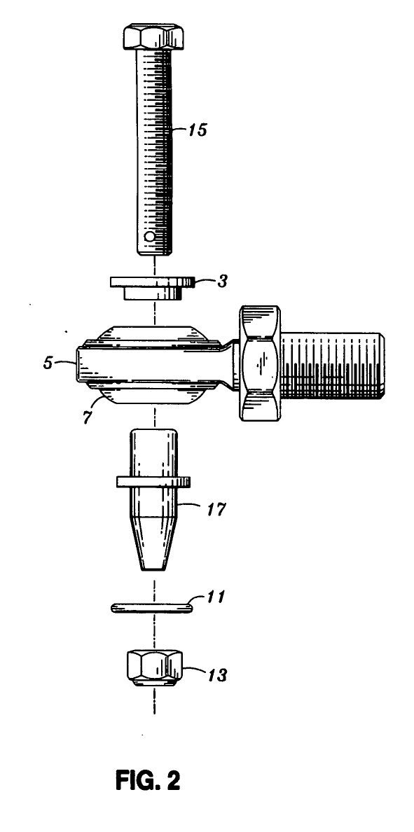

The Hime Joint comprises an annular shaped socket. The socket encases a freely movable ball shaped member with an included opening in the center. The presently preferred embodiment is a two piece (upper and lower) tapered or straight insert, which is mounted and secured within the included opening of the freely movable ball shaped member of the Hime Joint. This embodiment is attached to the ball shaped member by either a bolt securing the upper and lower portions together (see FIG. 1) or a bolt passed entirely through the embodiment which is secured by a nut on the bottom (see FIG. 2). The presently preferred embodiment is the stronger and more preferable of the two although both achieve the same end result.

The normal vehicle suspension system comprises an upper and lower suspension arm, an upper and lower ball joint and a steering knuckle. Additionally it includes tie rods to which tie rod ends are attached. These tie rod ends are attached to a steering stem or steering box which enables the vehicle to be steered. The new embodiment is and/or can be used at the end of the upper and lower suspension arms where attached to the spindle and at the ends of the tie rods where attached to the steering stem or box and the steering knuckle.

The vehicle suspension system improvement is comprised of the following steps:
Removing the distal tie rod end and replacing it with a Hime joint including an annular shaped socket encasing a freely movable ball shaped member having an included opening therein.
Installing an upper and a lower tapered or straight insert into the included opening of the ball shaped member and securing the upper and lower inserts by fastening means; and attaching the lower tapered or straight insert to the steering arm.
Removing the proximal tie rod end and replacing it with a Hime joint including an annular shaped socket encasing a freely movable ball shaped member having an included opening therein.
Installing an upper and a lower tapered or straight insert into the included opening of the ball shaped member and securing the upper and lower inserts by fastening means, and
Attaching the lower tapered or straight insert to the spindle, thereby enhancing the vertical and horizontal travel of the suspension system.

So installed, the greater rotational capability of the Hime Joint when combined with the new embodiment will achieve greater vertical and horizontal travel with respect to the pivot points of the upper and lower suspension arms. Additionally it will have greater strength, reduced weight, create less friction and have a lower replacement cost than the items described in the above Description of the Prior Art. Used properly it will dramatically improve the on and off-road handling capabilities of the vehicle and vehicle suspension system to which it is attached.

Although the description above contains many specifications, these should not be construed as limiting the scope of the invention, but as merely providing illustrations of some of the presently preferred embodiments of the invention.

1) an improved vehicle suspension system in which a conventional suspension system having a tie rod in which the distal end of the tie rod is connected to a steering arm and the proximal end is attached to a spindle whereby the improvement comprises removing the distal tie rod end and replacing it with a hime joint including an annular shaped socket encasing a freely movable ball shaped member having an included opening therein; installing an upper and a lower tapered insert into the included opening of the ball shaped member and securing the upper and lower inserts by fastening means; and attaching the lower tapered insert to the steering arm; removing the proximal tie rod end and replacing it with a hime joint including an annular shaped socket encasing a freely movable ball shaped member having an included opening therein; installing an upper and a lower tapered insert into the included opening of the ball shaped member and securing the upper and lower inserts by fastening means; and attaching the lower tapered insert to the spindle, thereby enhancing the vertical and horizontal travel of the suspension system:

2) An improved vehicle suspension system in which a conventional suspension system having a tie rod in which the distal end of the tie rod is connected to a steering arm and the proximal end is attached to a spindle whereby the improvement comprises removing the distal tie rod end and replacing it with a Hime joint including an annular shaped socket encasing a freely movable ball shaped member having an included opening therein; installing an upper and a lower straight insert into the included opening of the ball shaped member and securing the upper and lower inserts by fastening means; and attaching the lower straight insert to the steering arm; removing the proximal tie rod end and replacing it with a Hime joint including an annular shaped socket encasing a freely movable ball shaped member having an included opening therein; installing an upper and a lower straight insert into the included opening of the ball shaped member and securing the upper and lower inserts by fastening means; and attaching the lower straight insert to the spindle, thereby enhancing the vertical and horizontal travel of the suspension system.
